(19) United States
(12) Patent Application Publication
(10) Pub. No.: US 2009/0034810 A1
(43) Pub. Date: Feb. 5, 2009

(54) Abnormal tissue pattern detection apparatus, method and program

(75) Inventor: Jonathan David Oakley, Pleasanton, CA (US)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/882,743

(22) Filed: Aug. 3, 2007

(51) Int. Cl. G06K 9/00

(52) U.S. Cl. 382/128

(57) ABSTRACT

An abnormal tissue pattern detection apparatus capable of accurately detecting abnormal tissue pattern candidates by mutually compensating for the disadvantage of the processing using a morphology filter and the disadvantage of the processing using a Laplacian filter. When an image is inputted, a first candidate detection section detects first abnormal tissue pattern candidates by performing filtering using a morphology filter. At the same time, a second candidate detection section detects second abnormal tissue pattern candidates by performing filtering using a Laplacian filter. A determination section detects a second abnormal tissue pattern candidate, with which a first abnormal tissue pattern candidate overlaps, as a final abnormal tissue pattern candidate.

### BACKGROUND OF THE INVENTION

1. Field of the Invention

The present invention relates to an abnormal tissue pattern detection apparatus and method, and a program for causing a computer to execute the abnormal tissue pattern detection method.

2. Description of the Related Art

In the medical field, the so-called computer-aided diagnosis (CAD) is known. CAD is a computer system that automatically detects abnormal tissue pattern candidates in an image, and displays the detected abnormal tissue pattern candidates by highlighting or the like.

In the meantime, known methods for detecting abnormal tissue pattern candidates include, for example, a method that automatically detects candidate patterns of tumor, a form of breast cancer or the like (one of the types of abnormal tissue patterns), by performing image processing on a breast radiation image (mammogram) using an iris filter and threshold processing the output, and a method that automatically detects candidate patterns of calcification, another form of breast cancer or the like (one of the types of abnormal tissue patterns), by performing image processing using a morphology filter and threshold processing the output as described, for example, in U.S. Pat. No. 5,761,334). Further, a method that detects abnormal tissue pattern candidates using a Laplacian filter is also proposed.

Here, the filtering using the morphology filter has a disadvantage that it may not accurately detect the shapes of calcification, although it may detect the candidate patterns of calcification relatively accurately. On the other hand, the filtering using the Laplacian filter has a disadvantage that it would yield many false positives, although it may accurately detect the shapes of calcification.

### SUMMARY OF THE INVENTION

The present invention has been developed in view of the circumstances described above, and it is an object of the present invention to provide an abnormal tissue pattern detection apparatus and method capable of accurately detecting abnormal tissue pattern candidates by mutually compensating for the disadvantage of the processing using a morphology filter and the disadvantage of the processing using a Laplacian filter. It is a further object of the present invention to provide a program for causing a computer to execute the abnormal tissue pattern detection method.

An abnormal tissue pattern candidate detection apparatus of the present invention includes:

a first candidate detection means for detecting first abnormal tissue pattern candidates by performing filtering on a medical image using a morphology filter; and

a second candidate detection means for detecting second abnormal tissue pattern candidates by performing filtering on the medical image using a Laplacian filter,

wherein a first candidate image containing only the first abnormal tissue pattern candidates, and a second candidate image containing only the second abnormal tissue pattern candidates are placed on top of each other, and a second abnormal tissue pattern candidate, with which a first abnormal tissue pattern candidate overlaps, is detected as a final abnormal tissue pattern candidate.

The abnormal tissue pattern candidate detection apparatus of the present invention may further include:

a false positive candidate elimination means for performing an elimination process to eliminate false positive candidates from the abnormal tissue pattern candidates;

a proximity characteristic amount calculation means for calculating the ratio of the number of the false positive candidates to the number of the abnormal tissue pattern candidates included in a predetermined region surrounding each of remaining abnormal tissue pattern candidates, remaining after the elimination process, as a proximity characteristic amount; and

a determination means for determining whether or not each of the remaining abnormal tissue pattern candidates is a false positive candidate based on the proximity characteristic amount.

In this case, the proximity characteristic amount calculation means may be a means for calculating, with respect to each of the remaining abnormal tissue pattern candidates, the ratio of the number of the false positive candidates to the number of the abnormal tissue pattern candidates included in the predetermined region as the proximity characteristic amount.

Further, the proximity characteristic amount calculation means may be a means for combining the predetermined region with respect to each of the remaining abnormal tissue pattern candidates if the region overlaps with each other, and calculating the ratio of the number of the false positive candidates to the number of the abnormal tissue pattern candidates included in the combined predetermined regions as the proximity characteristic amount.

Still further, the determination means may include a discriminator, learned through a machine learning process, which outputs a discrimination result indicating whether or not each of the remaining abnormal tissue pattern candidates is a false positive candidate using characteristic amounts thereof, including the proximity characteristic amount, as input.

Further, the determination means may be a means for determining each of the remaining abnormal tissue pattern candidates as a false positive candidate when the proximity characteristic amount is greater than or equal to a predetermined threshold value.

As for the “machine learning process”, the process of neural network, boosting, support vector machine, or the like may be used. For example, in the case of support vector machine, a discriminator that has learned various types of characteristic amounts, including proximity characteristic amounts, extracted from multitudes of images known to be of abnormal tissue patterns, and various types of characteristic amounts, including proximity characteristic amounts, extracted from multitudes of images known to not be of abnormal tissue patterns may be obtained. Then, by inputting an abnormal tissue pattern candidate to the discriminator, a discrimination result indicating whether or not the candidate is an abnormal tissue pattern may be obtained.

An abnormal tissue pattern candidate detection method of the present invention includes the steps of:

detecting first abnormal tissue pattern candidates by performing filtering on a medical image using a morphology filter;

detecting second abnormal tissue pattern candidates by performing filtering on the medical image using a Laplacian filter; and

placing a first candidate image containing only the first abnormal tissue pattern candidates, and a second candidate image containing only the second abnormal tissue pattern candidates on top of each other, and detecting a second abnormal tissue pattern candidate, with which a first abnormal tissue pattern candidate overlaps, as a final abnormal tissue pattern candidate.

Note that the abnormal tissue pattern detection method may be provided in the form of a program that causes a computer to execute the method.

According to the present invention, filtering using a morphology filter is performed on a medical image and first abnormal tissue pattern candidates are detected. Further, another filtering using a Laplacian filter is also performed on the medical image and second abnormal tissue pattern candidates are detected. Then a first candidate image containing only the first abnormal tissue pattern candidates, and a second candidate image containing only the second abnormal tissue pattern candidates are placed on top of each other, and a second abnormal tissue pattern candidate, with which a first abnormal tissue pattern candidate overlaps, is detected as a final abnormal tissue pattern candidate.

This may mutually compensate for the disadvantage of the filtering using a morphology filter that may not accurately detect shapes of calcification, although it may detect candidate calcification patterns relatively accurately, and the disadvantage of the filtering using a Laplacian filtering that it would yield many false positives, although it may accurately detect shapes of calcification. As a result, abnormal tissue pattern candidates may be detected accurately, including the shapes thereof.

### BRIEF DESCRIPTION OF THE DRAWINGS

FIG. 1 is a schematic block diagram of the abnormal tissue pattern detection apparatus according to an embodiment of the present invention.

FIG. 2 illustrates a concept of structural elements used in morphology processing.

FIGS. 3A to 3D illustrate basic functions of the morphology processing.

FIGS. 4A to 4E illustrate a process performed in the candidate detection section shown in FIG. 1.

FIG. 5 is an enlarged view of a vessel included in an image for illustrating how to calculate the proximity characteristic amount (first view).

FIG. 6 is an enlarged view of a vessel included in an image for illustrating how to calculate the proximity characteristic amount (second view).

FIG. 7 is a flowchart illustrating a process performed in the present embodiment.

FIG. 8 is an enlarged view of a vessel included in an image for illustrating how to calculate the proximity characteristic amount (third view).

### DESCRIPTION OF THE PREFERRED EMBODIMENTS

Hereinafter, an exemplary embodiment of the present invention will be described with reference to the accompanying drawings. Here, the description will be made of a case in which a mammogram representing a human breast is used as a “medical image” and candidate patterns of calcification are extracted as “abnormal tissue pattern candidates”.

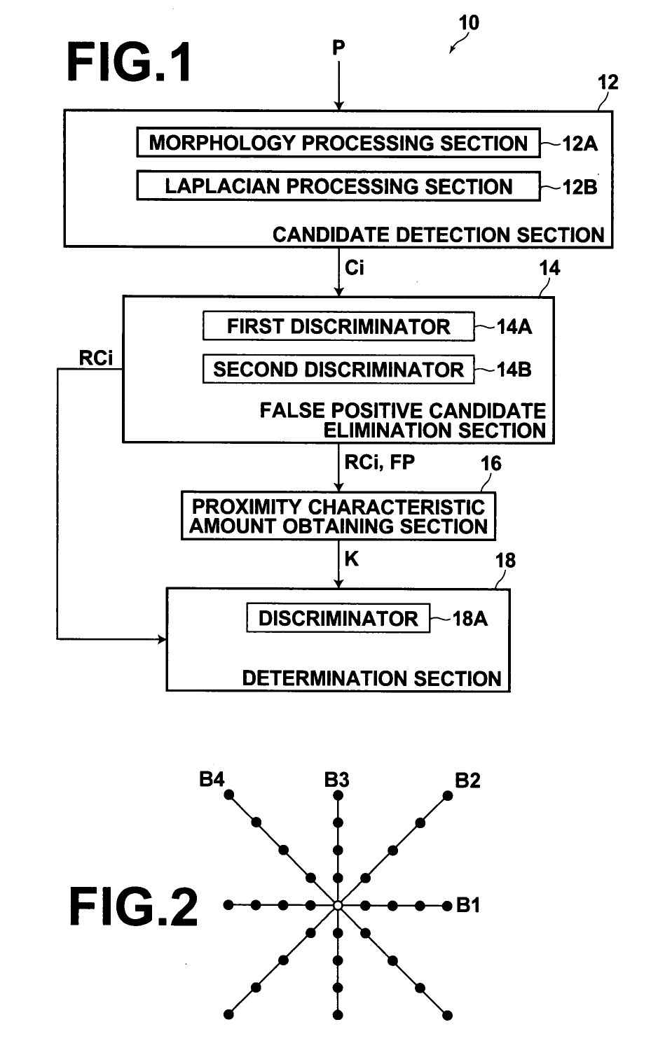

FIG. 1 is a schematic block diagram of the abnormal tissue pattern detection apparatus according to an embodiment of the present invention, illustrating the construction thereof. As illustrated, the abnormal tissue pattern detection apparatus 10 according to the present embodiment includes: a candidate detection section 12 that detects candidate patterns Ci (i=1, 2, 3, - - - ) of abnormal tissue (calcification) in an breast image P, which is the diagnosis target image, based on image data P representing the breast image P (image and image data representing the image are given the same reference symbol for clarity); a false positive candidate elimination section 14 that performs an elimination process to eliminate false positive candidates FP from the candidate patterns Ci; a proximity characteristic amount calculation section 16 that calculates the ratio of the number of the false positive candidates FP to the number of candidate patterns Ci of abnormal tissue included in a predetermined area surrounding each of remaining candidate patterns RCj (j=1, 2, 3, - - - ), remaining after the elimination process, (remaining candidate patterns) as a proximity characteristic amount K; and a determination section 18 that determines whether or not each of the remaining candidate patterns RCj is a false positive candidate FP based on the proximity characteristic amount K. Here, it is assumed that the image data P includes high luminance and high level signals.

The candidate detection section 12 includes a morphology processing section 12A and a Laplacian processing section 12B, and detects the candidate patterns Ci of abnormal tissue from the breast image P by performing filtering using both a morphology filter and a Laplacian filter in the morphology processing section 12A and Laplacian processing section 12B (hybrid process). Filtering using the morphology filter (morphology processing) will be described first. The candidate detection section 12 performs an arithmetic operation on image data P according to Formula (1) below, and obtains an output value Mo.

$$Mo = P - {max}_{i = 1 , … , M} \{ ( P ⊖ {B}_{i} ) ⊕ {B}_{i} \} \qquad ( 1 )$$

where, Bi represents M straight structural elements B illustrated in FIG. 2 (i=1, 2, 3, 4 in FIG. 2), and the mask size, which is the size of the structural elements B, is set greater than the size of the detection target pattern of calcification.

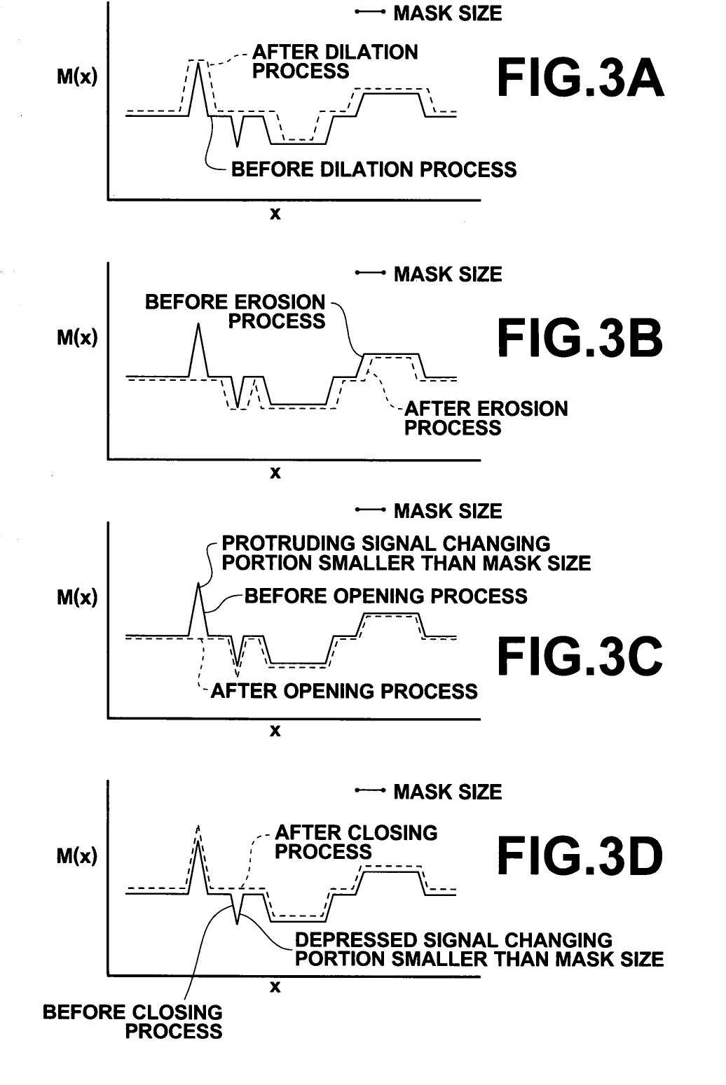

In Formula (1), a searching process for a minimum value within a predetermined width centered on an attention pixel determined according to the structural elements B (erosion process, FIG. 3B) is performed first, then a searching process for a maximum value within the predetermined width (dilation process, FIG. 3A) is performed (collectively, opening process, FIG. 3C). In FIG. 3A to 3D, the mask size is the size of the structural elements B. Through the opening process, a pattern of calcification, which is a protruding data changing portion smaller than the structural elements B (image portion spatially fluctuating in a narrow range), is removed.

In the mean time, an elongated pattern of non-calcification longer than the structural elements, and has a gradient (extending direction) corresponding to any one of the M structural elements Bi remains as it is (second term in Formula (1)). Thus, an image containing only candidate patterns of calcification is obtained by subtracting the smoothed image (image from which calcification patterns are removed) obtained by the opening process from the image P.

In the case of high density and high level signals, the pattern of calcification has a lower density than that of the surrounding image portion, and the pattern of calcification appears as a depressed signal changing portion with respect to the surrounding portion, so that a closing operation is applied instead of the opening process, i.e., Formula (2) below is applied instead of Formula (1) (FIG. 3D). Through the closing process, a pattern of calcification, which is a changing portion appearing as a depression smaller than the structural elements B may be eliminated.

$$Mo = P - {min}_{i = 1 , … , M} \{ ( P ⊕ {B}_{i} ) ⊖ {B}_{i} \} \qquad ( 2 )$$

There may be cases where some of the patterns of non-calcification having a size corresponding to that of the pattern of calcification still remain. In such a case, patterns of non-calcification included in Mo of Formula (1) are further removed using differential information, which is based on morphology processing according to Formula (3) below.

$${M}_{grad} = \frac{1}{2} ( P ⊕ λ B - P ⊖ λ B ) \qquad ( 3 )$$

Here, a greater value of M_{grad} indicates a higher probability of the pattern of calcification, so that a candidate image Cs containing only candidate patterns of calcification may be obtained by Formula (4) below.

IF Mo(i,j)≧T1 and M_{grad}(i,j)≧T2

Then Cs(i,j)=Mo else Cs(i,j)=0 (4)

where, T1 and T2 are experimentally obtainable predetermined threshold values.

Note that a pattern of non-calcification having a different size from that of the pattern of calcification may be removed only by comparing the Mo of Formula (1) with a predetermined threshold value T1. Therefore, in the case where patterns of non-calcification having an equivalent size to that of the pattern of calcification may not remain, only the condition of the first term of Formula (4) (Mo(i, j)≧T1) needs to be satisfied.

Finally, clusters Cmc of patterns of calcification, which are abnormal tissue pattern candidates based on the morphology processing, are detected by the combination of multi-scale opening and closing processes shown in Formula (5) below.

C_{mc}=Cₛ⊕λ₁B⊖λ₃B⊕λ₂B (5)

where, λ1 and λ2 are determined by a maximum distance between the patterns of calcification to be merged and a maximum radius of an isolated pattern to be removed, having a relation ship of λ3=λ1+λ2.

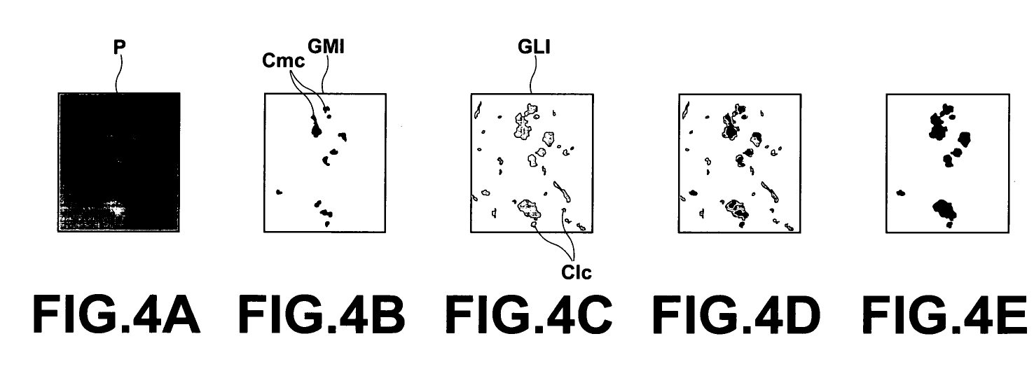

Through the process described above, a candidate image GMI illustrated in FIG. 4B, which contains only candidate patterns of calcification based on the morphology processing, may be obtained from the image P shown in FIG. 4A.

Next, filtering using a Laplacian filter (Laplacian processing) will be described. The candidate detection section 12 performs an arithmetic operation on the image data P according to Formula (6) below, and detects edges E of a pattern of calcification.

E=f·P(i,j) (6)

where, “f” is a two-dimensional Laplacian filter. Then, the candidate detection section 12 clusters regions enclosed by the edges E and detects them as a cluster Clc. This yields a candidate image GLI, which contains only candidate patterns of calcification based on the Laplacian processing illustrated in FIG. 4C, from the image P illustrated in FIG. 4A.

Thereafter, the candidate detection section 12 places the candidate image GMI and candidate image GLI on top of each other, and detects a cluster Clc of the candidate image GLI, with which a cluster Cmc of the candidate image GMI overlaps, as a final candidate pattern Ci of abnormal tissue (FIG. 4E).

Here, the candidate patterns of calcification may be detected relatively accurately through the morphology processing, but the shapes thereof may not be detected accurately. On the other hand, the shapes of calcification may be detected accurately by the Laplacian processing, but the Laplacian processing has a disadvantage that it would yield many false positives.

As in the present embodiment, by performing a hybrid process using both the morphology and Laplacian filters, the candidate patterns Ci of abnormal tissue may be detected accurately, including the shapes thereof.

The false positive candidate elimination section 14 eliminates the patterns of calcification deposited within the vessels of the breast (in-vessel deposited calcification), included in the candidate patterns Ci of abnormal tissue, from the candidate patterns Ci as false positive candidates FP. Removal of the patters of in-vessel deposited calcification will be described first.

The false positive candidate elimination section 14 sets a rectangular region ROI, having a predetermined size (e.g., 64×64 pixels), on the image P centered on each of the candidate patterns Ci. Here, each of the candidate patterns Ci occupies a certain area, so that the ROI is set centered on the gravity center of the area as the center of each of the candidate patterns Ci. Thereafter, the false positive candidate elimination section 14 performs the following for each ROI. First, edges of the vessels are highlighted by performing filtering using a Sobel filter, and a binary image is obtained through binarization using a predetermined threshold value. Then, characteristic amounts, such as the number of edges, the number of pixels in a largest edge, and the like, are calculated from the binary image, and the calculated characteristic amounts of the binary image are inputted to a first discriminator 14A.

The first discriminator 14A is a discriminator learned through a machine learning process, for example, support vector machine, using characteristic amounts obtained from multitudes of in-vessel deposited calcification images as correct data, and characteristic amounts obtained from multitudes of images that do not include in-vessel deposited calcification as incorrect data, and when the characteristic amounts of the binary image are inputted, it outputs a discrimination result indicating whether or not the image is an in-vessel deposited calcification image.

Then, linear fitting is performed only on the binary image within the ROI centered on each of the candidate patterns Ci, which is discriminated by the first discriminator 14A as an in-vessel deposited calcification image, and the direction of the straight lines forming the walls of a tubular object within the ROI is estimated roughly. Then, tracking is performed along the estimated lines, first roughly, then finely, to make the straight lines forming the walls as continued lines. Thereafter, characteristic amounts, such as the gradient of the lines forming the walls, distance between them, and the like, are calculated, and the calculated characteristic amounts of the vessel candidate are inputted to a second discriminator 14B learned for vessel discrimination.

The second discriminator 14B is a discriminator learned through a machine learning process, using characteristic amounts obtained from multitudes of vessel images as correct data, and characteristic amounts obtained from multitudes of non-vessel images as incorrect data, and when the characteristic amounts of the vessel candidate are inputted, it outputs a discrimination result indicating whether or not the candidate is a vessel.

Here, the tracking is performed with respect to each ROI, so that the region discriminated as a vessel in each ROI is connected to each other, and each of the candidate patterns Ci within the region of connected vessel is deemed as a false positive candidate FP of in-vessel deposited calcification, and eliminated from the candidate patterns Ci.

The method for detecting the patterns of in-vessel deposited calcification is not limited to the method described above, and various known methods may be used, including the method described in Japanese Unexamined Patent Publication No. 2005-224428, and the like.

The false positive candidates FP of in-vessel deposited calcification may be eliminated in the manner as described above, but small false positive candidates may not be eliminated completely. Therefore, in the present embodiment, the following are performed in the proximity characteristic amount calculation section 16 and determination section 18 in order to eliminate small false positive candidates.

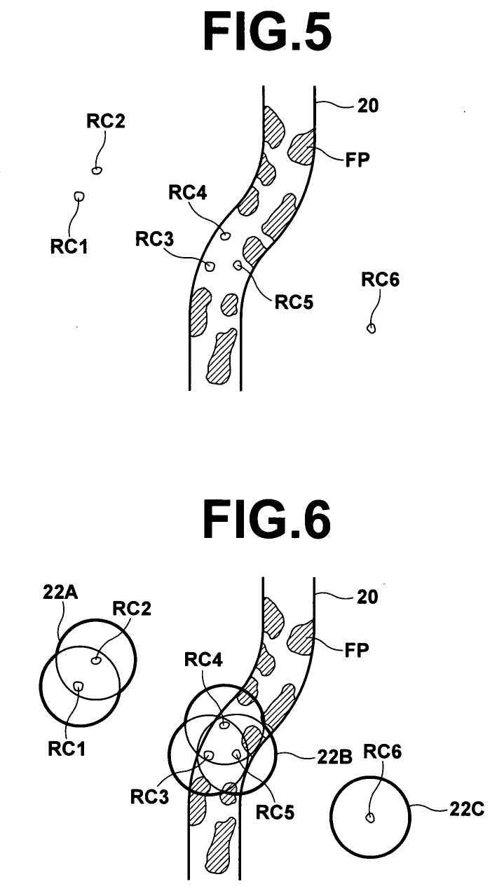

The proximity characteristic amount calculation section 16 calculates a proximity characteristic amount K for each of the remaining candidate patterns RCj, remaining after the false positive candidates FP are eliminated. FIG. 5 is an enlarged view of a vessel included in an image used for illustrating how to calculate the proximity characteristic amount K. As illustrated, a plurality of candidate patterns Ci is included in the vessel region 20, of which relatively large candidate patterns Ci are false positive candidates FP (indicated by slashes) and relatively small candidate patterns Ci are the remaining candidate patterns RCj. Further, some of the remaining candidate patterns RCj are also present at places away from the vessel region 20. In FIG. 5, six remaining candidate patterns RCj are present, which are referenced as RC 1 to RC 6 respectively.

The proximity characteristic amount calculation section 16 sets circular regions, each having a predetermined radius centered on the gravity center of each of the remaining candidate patterns RCj, as illustrated in FIG. 6, and circular regions overlapping with each other are combined together to form a single cluster. The radius of the circular region is experimentally determined in advance, for example, 20 mm here. The two circular regions centered respectively on the remaining candidate patterns RC1 and RC2 overlap with each other, so that they are designated as a single cluster 22A. Further, three circular regions centered respectively on the remaining candidate patterns RC3 to RC5 also overlap with each other, so that they are designated as a single cluster 22B. For the remaining candidate pattern RC6, a circular region centered on the remaining candidate pattern RC6 is designated as a single cluster 22C.

Here, the proximity characteristic amount calculation section 16 deems a cluster formed only by a single remaining candidate pattern RCj as a false positive candidate FP, on grounds that it is an isolated point, and excludes the cluster from the calculation of proximity characteristic amount K. In the present embodiment, the cluster 22C of the remaining candidate pattern RC6 is excluded from the calculation of the proximity characteristic amount K.

Then, the proximity characteristic amount calculation section 16 counts the total N1 of the number of remaining candidate patterns RCj and the number of the candidate patterns Ci, including false positive candidates FP, and the number N2 of the false positive candidates FP contained in the clusters. In FIG. 6, the cluster 22A contains two candidate patterns Ci, but does not contain any false positive candidate FP, which results in N1=2 and N2=0. The cluster 22B contains eight candidate patterns Ci and five false positive candidates FP, which results in N1=8 and N2=5. Thereafter, a value of N2/N1 is calculated as the proximity characteristic amount K for each cluster. In FIG. 6, K=0 for the cluster 22A, and K=0.625 for the cluster 22B.

The determination section 18 receives input of the proximity characteristic amount K and each of the remaining candidate patterns RCj, calculates characteristic amounts, including the area and brightness of each of the remaining candidate patterns RCj and the like, and inputs the calculated characteristic amounts to a discriminator 18A.

The discriminator 18A is a discriminator learned through a machine learning process, for example, support vector machine, using characteristic amounts (including proximity characteristic amounts K) obtained from multitudes of abnormal tissue pattern images as correct data, and characteristic amounts obtained from multitudes of non-abnormal tissue pattern images as incorrect data, and when the characteristic amounts of an abnormal tissue pattern candidate are inputted, it outputs a discrimination result indicating whether or not the candidate is an abnormal tissue pattern.

In response to the discrimination result from the discriminator 18A, the determination section 18 outputs a determination result indicating whether or not each of the remaining candidate patterns RCj is an abnormal tissue pattern.

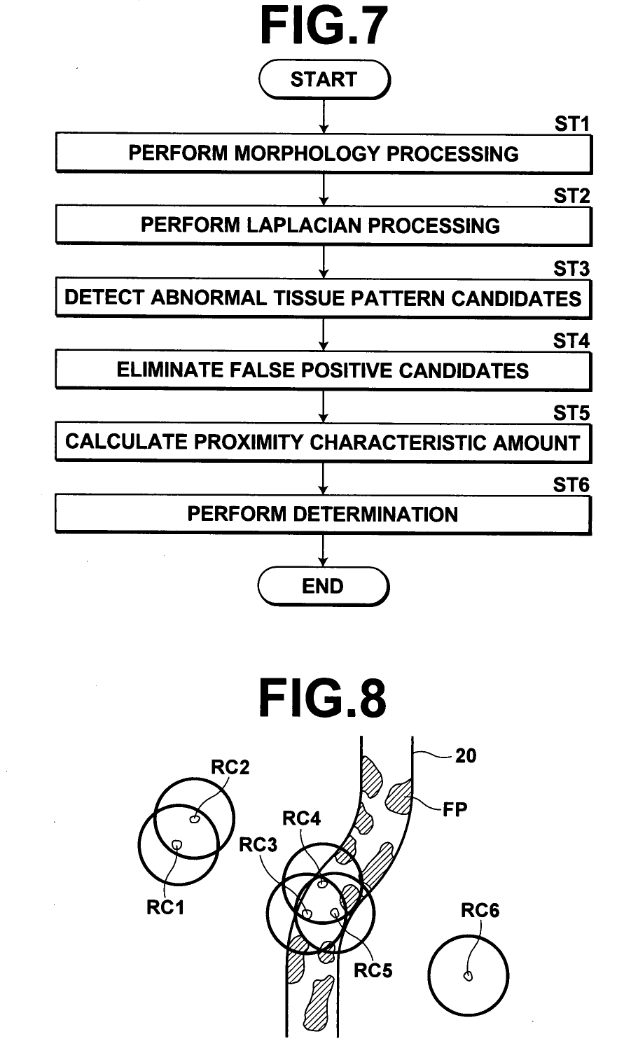

A process performed in the present embodiment will be described next. FIG. 7 is a flowchart illustrating the process performed in the present embodiment. When an image P is inputted, the morphology processing section 12A of the candidate detection section 12 performs filtering using a morphology filter and detects clusters Cmc of calcification pattern, which are the abnormal tissue pattern candidates based on the morphology processing (step ST1). In the mean time, the Laplacian processing section 12B performs filtering using a Laplacian filter and detects clusters Clc of calcification pattern, which are the abnormal tissue pattern candidates based on the Laplacian processing (step ST2). Note that either the step ST1 or step ST2 may be performed first, or they may be performed at the same time. Then, the candidate detection section 12 detects a cluster Clc, with which a cluster Cmc overlaps, as a final candidate Ci of the abnormal tissue pattern (step ST3).

Then, the false positive candidate elimination section 14 eliminates false positive candidates FP from the candidate patterns Ci (step ST4). The proximity characteristic amount calculation section 16 calculates the proximity characteristic amount K (step ST5), and determination section 18 determines whether or not each of the remaining candidate patterns RCj is an abnormal tissue pattern based on the proximity characteristic amount K (step ST6), and the process is terminated.

As described above, in the present embodiment, a cluster Clc, which is the abnormal tissue pattern candidate based on the Laplacian processing, with which a cluster Cmc, which is the abnormal tissue pattern candidate based on the morphology processing, overlaps, is detected as a candidate pattern Ci of abnormal tissue. This may mutually compensate for the disadvantage of the morphology processing that it may not accurately detect the shapes of calcification, although it may detect the candidate patterns of calcification relatively accurately, and the disadvantage of the Laplacian processing that it would yield many false positives, although it may accurately detect the shapes of calcification. As a result, abnormal tissue pattern candidates may be detected accurately, including the shapes thereof.

In the embodiment described above, circular regions, each having a predetermined radius centered on the gravity center of each of the remaining candidate patterns RCj, which overlap with each other are combined together to form a single cluster, when calculating the proximity characteristic amount K in the proximity characteristic amount calculation section 16. But, a configuration may be adopted in which the total N1 of the number of the remaining candidate patterns RCj and the number of the candidate patterns Ci, including false positive candidates FP, and the number N2 of the false positive candidates contained in each circular region, as illustrated in FIG. 8, and a value of N2/N1 is calculated, as the proximity characteristic amount K with respect to each circular region.

Still further, in the embodiment described above, description has been made of a case in which the determination section 18 uses a discriminator learned through a machine learning process. But a configuration may be adopted in which the value of the proximity characteristic amount K calculated by the proximity characteristic amount calculation section 16 is compared with a predetermined threshold value, and each of the remaining candidate patterns RCj is determined to be an abnormal tissue pattern, if the proximity characteristic amount is smaller than the threshold value. For example, in FIG. 6, if the predetermined threshold value is 0.5, the remaining candidate patterns RC1 and RC2 contained in the cluster 22A are determined to be abnormal tissue patterns, since the proximity characteristic amount K for the cluster 22A is 0. While, the proximity characteristic amount K calculated for the cluster 22B is 0.625, so that the remaining candidate patterns RC3, RC4 and RC5 are determined not to be abnormal tissue patterns.

Further, in the embodiment describe above, determination of the abnormal tissue pattern may be made through the method using the Mahalanobis distance as described, for example, in Japanese Unexamined Patent Publication Nos. 9 (1997)-167238 and 2002-74361. Hereinafter, the method using the Mahalanobis distance will be described.

The Mahalanobis distance means Dmi defined by Formula (7) below, which is a distance measured from the center of distribution of characteristic amounts of abnormal and benign patterns and with the weighting of a hyper-ellipsoid expressed by a covariance matrix

$$D mi = {( {x}^{->} - {mi}^{->} )}^{t} {\sum }_{i}^{- 1} ( {x}^{->} - {mi}^{->} ) \qquad ( 7 )$$

where, Σᵢ represents the covariance matrix of pattern class (pattern classification between benign pattern of i=1 and anbormal pattern of i=2), that is,

$${\sum }_{i} = ( 1 / Ni ) {\sum }_{x ∈ wi} ( {x}^{->} - {mi}^{->} ) {( {x}^{->} - {mi}^{->} )}^{t}$$

t represents the transposed vector (row vector),

\vec{x} is the vector of characteristic amounts including proximity characteristic amounts K, that is,

$$\begin{matrix}{x}^{->} = ( x 1 , x 2 , … , xN ) \\ {\sum }_{i}^{- 1} is the inverse matrix of {\sum }_{i} , \\ {mi}^{->} is the average of the pattern class wi , that is , \\ {mi}^{->} = ( 1 / Ni ) {\sum }_{x ∈ wi} {x}^{->}\end{matrix}$$

The determination section 18 calculates the Mahalanobis distance Dm1 with respect to the pattern class (i=1), which represents the benign pattern obtained experimentally in advance, and the Mahalanobis distance Dm2 with respect to the pattern class (i=2), which represents the abnormal tissue pattern obtained experimentally in advance, according to Formula (7). The Mahalanobis distances Dm1 and Dm2 are compared with each other to determine whether or not the candidate region is malignant. In the case where the Mahalanobis distance Dm1 with respect to the pattern class representing the benign pattern is shorter than the Mahalanobis distance Dm2 with respect to the pattern class representing the abnormal tissue pattern, i.e. in the case where Dm1<Dm2, the candidate region is determined to be a benign pattern. In the case where the Mahalanobis distance Dm2 with respect to the pattern class representing the abnormal tissue pattern is shorter than the Mahalanobis distance Dm1 with respect to the pattern class representing the benign pattern, i.e. in the case where Dm1>Dm2, the candidate region is determined to be an abnormal tissue pattern, and the determination result is outputted.

So far, the abnormal tissue pattern detection apparatus 10 according to an embodiment of the present invention has been described. A program for causing a computer to function as the means corresponding to the candidate detection section 12, false positive candidate elimination section 14, proximity characteristic amount calculation means 16, and determination section 18 described above, thereby causing the computer to execute the process illustrated in FIG. 7 is another embodiment of the present invention. Further, a computer readable recording medium on which such program is recorded is still another embodiment of the present invention.

What is claimed is:

1. An abnormal tissue pattern detection apparatus, comprising:
a first candidate detection means for detecting first abnormal tissue pattern candidates by performing filtering on a medical image using a morphology filter; and
a second candidate detection means for detecting second abnormal tissue pattern candidates by performing filtering on the medical image using a Laplacian filter,
wherein a first candidate image containing only the first abnormal tissue pattern candidates, and a second candidate image containing only the second abnormal tissue pattern candidates are placed on top of each other, and a second abnormal tissue pattern candidate, with which a first abnormal tissue pattern candidate overlaps, is detected as a final abnormal tissue pattern candidate.

2. The abnormal tissue pattern detection apparatus according to claim 1, further comprising:
a false positive candidate elimination means for performing an elimination process to eliminate false positive candidates from the abnormal tissue pattern candidates;
a proximity characteristic amount calculation means for calculating the ratio of the number of the false positive candidates to the number of the abnormal tissue pattern candidates included in a predetermined region surrounding each of remaining abnormal tissue pattern candidates, remaining after the elimination process, as a proximity characteristic amount; and
a determination means for determining whether or not each of the remaining abnormal tissue pattern candidates is a false positive candidate based on the proximity characteristic amount.

3. The abnormal tissue pattern detection apparatus according to claim 2, wherein the proximity characteristic amount calculation means is a means for calculating, with respect to each of the remaining abnormal tissue pattern candidates, the ratio of the number of the false positive candidates to the number of the abnormal tissue pattern candidates included in the predetermined region as the proximity characteristic amount.

4. The abnormal tissue pattern detection apparatus according to claim 2, wherein the proximity characteristic amount calculation means is a means for combining the predetermined region with respect to each of the remaining abnormal tissue pattern candidates, if the region overlaps with each other, and calculating the ratio of the number of the false positive candidates to the number of the abnormal tissue pattern candidates included in the combined predetermined regions as the proximity characteristic amount.

5. The abnormal tissue pattern detection apparatus according to claim 2, wherein the determination means comprises a discriminator, learned through a machine learning process, that outputs a discrimination result whether or not each of the remaining abnormal tissue pattern candidates is a false positive candidate using characteristic amounts thereof, including the proximity characteristic amount, as input.

6. The abnormal tissue pattern detection apparatus according to claim 2, wherein the determination means is a means for determining each of the remaining abnormal tissue pattern candidates as a false positive candidate when the proximity characteristic amount is greater than or equal to a predetermined threshold value.

7. An abnormal tissue pattern detection method, comprising the steps of:
detecting first abnormal tissue pattern candidates by performing filtering on a medical image using a morphology filter; and
detecting second abnormal tissue pattern candidates by performing filtering on the medical image using a Laplacian filter;
placing a first candidate image containing only the first abnormal tissue pattern candidates, and a second candidate image containing only the second abnormal tissue pattern candidates on top of each other, and detecting a second abnormal tissue pattern candidate, with which a first abnormal tissue pattern candidate overlaps, as a final abnormal tissue pattern candidate.

8. A computer readable recording medium storing a program for causing a computer to execute an abnormal tissue pattern detection method, comprising the steps of:
detecting first abnormal tissue pattern candidates by performing filtering on a medical image using a morphology filter; and
detecting second abnormal tissue pattern candidates by performing filtering on the medical image using a Laplacian filter;
placing a first candidate image containing only the first abnormal tissue pattern candidates, and a second candidate image containing only the second abnormal tissue pattern candidates on top of each other, and detecting a second abnormal tissue pattern candidate, with which a first abnormal tissue pattern candidate overlaps, as a final abnormal tissue pattern candidate.
